(19) United States
(12) Patent Application Publication
(10) Pub. No.: US 2005/0247635 A1
(43) Pub. Date: Nov. 10, 2005

(54) Adsorbents for removing heavy metal cations and methods for producing and using these adsorbents

(76) Inventors: Toan Phan Vo, Niskayuna, NY (US); Mark Randall Stouffer, Gahanna, OH (US)

Correspondence Address: COHEN & GRIGSBY, P.C., 11 STANWIX STREET, 15TH FLOOR, PITTSBURGH, PA, 15222, US

(21) Appl. No.: 11/014,295

(22) Filed: Dec. 16, 2004

Related U.S. Application Data
(63) Continuation-in-part of application No. 09/940,178, filed on Aug. 27, 2001, now Pat. No. 6,914,034.
(63) Continuation-in-part of application No. PCT/US03/39925, filed on Dec. 16, 2003.
(63) Continuation-in-part of application No. 11/006,084, filed on Dec. 7, 2004.
(63) Continuation-in-part of application No. 11/005,825, filed on Dec. 7, 2004.

(51) Int. Cl. B01D 15/00

(52) U.S. Cl. 210/685

(57) ABSTRACT

Adsorbents and methods for removing cations of heavy metals from a medium are provided. The adsorbents comprise a porous media in which at least one oxygen-containing compound of iron, copper, aluminum, zirconium, titanium and combinations thereof is incorporated. The oxygen-containing compound may be incorporated into the porous media by impregnation or dispersion of a suitable precursor of such a compound. The precursor may be further treated to yield the oxygen-containing compound. Such adsorbents are particularly useful for removing lead and/or other metal cations from the environment and may be used in treating drinking water sources.

### CROSS REFERENCE

This application is a continuation-in-part of copending U.S. patent application Ser. No. 09/940,178 filed on Aug. 27, 2001; and International Patent Application No. PCT/US/39925 filed on Dec. 16, 2003. This application is also a continuation-in-part of copending U.S. patent application Ser. Nos. 11/006,084 and 11/005,825 [Attorney Docket Nos. 01-159 CIP-A and 01-159 CIP-C] both filed on Dec. 7, 2004.

### FIELD OF INVENTION

The present invention relates to adsorbents for removing heavy metal cations from a medium adjacent thereto and methods for producing and using these adsorbents. In particular, the present invention relates to adsorbents for removing lead from water and to methods for producing and using these adsorbents.

### BACKGROUND OF THE INVENTION

It is widely known that heavy metals, such as lead, nickel, chromium and mercury, cadmium, etc., can be toxic to humans at low concentration levels. One cause for the presence of these heavy metals in the environment has been increasing industrial activities in the recent past. Lead is especially a problem in drinking water because piping in water distribution systems and in older plumbing fixtures often contains lead solder. The current Action Level for lead established by the United States Environmental Protection Agency (“EPA”) is 15 ppb and the maximum contaminant level (“MCL”) goal is zero. The current screening level for soil on residential properties is 400 ppm. Lead has been linked to delays in physical or mental development of children and deficits in attention span and learning abilities. In adults, lead has been linked to kidney problems and high blood pressure. Similarly, other metal cations have been linked to adverse health effects. For example, mercury and cadmium have been linked to kidney damage and chromium has been linked to cancers.

Different techniques have been used or proposed to remove lead and other metal cations from drinking water. Ion exchange resins can remove metal cations. However, other cations present in water as total dissolved solids (“TDS”) compete with heavy metals for the resin thus diluting ion exchange capacity and effectiveness. Also, ion exchange resin is not practical in many applications due to the change in size of the media with use.

Chemical processes to precipitate metal cations are commonly employed to remove contaminants from water, but these are not likely to lower metals concentrations to low ppb levels as required to meet stringent drinking water standards. Also, they are not practical for smaller scale applications.

Adsorbents have been developed for removal of specific metal cations including lead, for example, titanium silicate materials and specialty alumina media. These tend to be costly technologies. Iron oxide or hydroxide has been used for removal of metal anions, such as arsenic and selenium from water, and to a more limited extent iron oxides have been reportedly used for removal of metal cations. There is also literature that describes the capability of un-impregnated activated carbons for removal of metal cations and anions from aqueous solution. Un-impregnated activated carbon has been reported to have capacity for lead and other metal cations in solution. However, reported capacities are too low to be of practical significance in many applications.

No literature has been identified that documents the use of iron hydroxide incorporated on activated carbon for removal of lead or other metal cations. There are several references to the use of standard activated carbon, without impregnants, for removal of metal cations, for example, Abdel-Shafey, Hussein I., El-Gamal, Ibrahim M., Abdel-Sabour, M. F., Abo-El-Wafa, Ombarek, “Removal of Cadmium and Lead from Water by Activated Carbon,” Environmental Protection Engineering, Vol. 15 (1989); Kuennen et al., “Removal of Lead in Drinking Water by a Point-Of-Use Granular Activated Carbon Fixed Bed Adsorber,” CAS 93-12740-2-B, (1993); Cheng, Jianguo et al. “Adsorption of Low Levels of Lead (II) by Granular Activated Carbon” Journal of Environmental Science and Health, Part A: Environmental Science and Engineering (1993), A28(1), 51-71; Gajghate and Saxena, “Removal of Lead from Aqueous Solution by Active Carbon,” Indian J. Environ. Hlth. 1991: Vol. 33, No. 3, 374-379 (1991); Seco et al., “Adsorption of Heavy Metals from Aqueous Solutions onto Activated Carbon in Single Cu and Ni Systems and in Binary Cu—Ni, Cu—Cd and Cu—Zn Systems,” J. Chem. Tech. Biothechnol. 1997: 68, 23-30. (1997); Reed, Thomas E., Jamil, Maqbul., and Thomas, Bob, “Effect of pH, Empty Bed Contact Time and Hydraulic Loading Rate on Lead Removal by Granular Activated Carbon Columns,” Water Environment Research, Volume 68, Number 5, 877-882 (1996); Carriere, et al., “Effect of Influent Pb Concentration and Empty Bed Contact Time (EBCT) on Pb Removal by Granular Activated Carbon (GAC) Columns,” Dept. of Civil & Environ. Engr. West Virginia University, (1994); Netzer and Hughes, “Adsorption of Copper, Lead and Cobalt by Activated Carbon,” Water Res. 1984: Vol. 18, No. 8, 927-933 (1982); Arulanantham et al. “Coconut Shell Carbon for Treatment of Cadmium and Lead-Containing Wastewater,” Metal Finishing November 1989 (1989); Tan, T. C., and Teo, W. K., “Combined Effect of Carbon Dosage and Initial Adsorbate Concentration on the Adsorption Isotherm of Heavy Metals on Activated Carbon,” Wat. Res. 1987: Vol. 21, No. 10, 1183-1188 (1987); and Ferro-Garcia et al., “Removal of Lead from Water by Activated Carbons;” Carbon 1990: Vol. 28, No. 4, 545-552 (1990). Cations investigated included Pb, Cr, Cu, Co, Ni and Cd. Most of this work was conducted with higher concentrations than current action levels (low ppb levels). Because the work was conducted at higher concentrations (ppm levels), capacities measured were higher than would be the case at low ppb levels. The capacity for lead and other cations on standard, un-impregnated activated carbon at low concentration levels may be too low to be practical for most applications.

Hodi et al., “Removal of Pollutants from Drinking Water by Combined Ion Exchange and Adsorption Methods,” Environ. Int.: 21(3), 325-31. (1995); and Hlavay et al., “Application of New Adsorbents for Removal of Arsenic from Drinking Water;” Stud. Environ. Sci.: 34 (1988), describe adsorbent materials in which iron hydroxide is supported on alumina for removal of metals.

Singh, D. K., and Lal, Jyotsna, “Removal of Toxic Metal Ions from Waste Water by Coal-Based Adsorbent,” Department of Chemistry, Hercourt Butler Technological Institute: 37-42 (1992), describe a process for impregnating coal (raw un-activated and thus with no porosity) with iron hydroxide for arsenic removal. The process is similar to the process used to make the subject invention. However, the base material is not porous and the capacity was low.

Reed Brian E., Vaughan, Ronald., and Jiang, Liqiang. “As(III), As(V), Hg, and Pb Removal by Fe-Oxide Impregnated Activated Carbon.” Journal of Environmental Engineering September 2000: 869-873 describe “iron oxide impregnated” activated carbon for removal of arsenic, lead and mercury. The process for making the carbon is not described in detail, but it refers specifically to Iron (III) oxide, not iron hydroxide as the active material. The preferred embodiment of the current invention is the use of iron oxide as the impregnant.

Azizian et al., “Simultaneous Removal of Cu(II), Cr(VI), and As(V) Metals from Contaminated Soils and Groundwater,” Prepr. Ext. Abstr. ACS Natl. Meet., Am. Chem. Soc., Div. Environ. Chem. 40(1), 16-18 (2000), describe the removal of lead, chromium and arsenic by iron oxide (magnetite) supported on sand.

Use of unsupported ferric hydroxide for metals removal is described in a number of references, for example in Jekel, M., and Seith, R. “Comparison of Conventional and New Techniques for the Removal of Arsenic in a Full Scale Water Treatment Plant,” Water Supply: 18(1/2), 628-631 (2000); and Holy et al. (1998).

Therefore, there is a need to provide simple, convenient and cost-effective materials and methods for removing heavy metals cations from the environment at low ppb concentration levels.

### SUMMARY OF THE INVENTION

The present invention provides adsorbents and methods for removing heavy metals that exist as cations from the environment. Such heavy metals include, for example, lead, copper, nickel, cobalt, cadmium, zinc, mercury and combinations thereof. An adsorbent of the present invention for removing heavy metals existing in a cationic form comprises a porous media such as a carbon adsorbent wherein at least one oxygen-containing compound of a metal has been incorporated into the adsorbent. The metal is selected from the group consisting of iron, copper, aluminum, zirconium, titanium and combinations thereof. Iron is the preferred metal. A preferred class of oxygen compounds is metal hydroxides.

In an embodiment of the present invention, metal compound or compounds are incorporated into the carbon adsorbent by a method consisting of impregnating and/or dispersing said metal(s) in the carbon adsorbent.

Another embodiment of the present invention provides a method for producing a carbon adsorbent capable of removing heavy metals that comprises the steps of: (1) providing a porous carbon adsorbent; (2) incorporating at least one compound of a metal selected from the group consisting of iron, copper, aluminum, zirconium, titanium and combinations thereof into or onto the carbon adsorbent; and (3) converting the metal-containing compound into at least one oxygen-containing compound.

In another embodiment, a method is provided for producing a carbon adsorbent capable of removing heavy metals comprising the steps of: (1) providing a carbonaceous material; (2) mixing at least one compound of a metal selected from the group consisting of iron, copper, aluminum, zirconium, titanium and combinations thereof into the carbonaceous material; (3) forming the mixture into particles of a carbonaceous material containing said metal; and (4) converting the particles of said carbonaceous material containing said metal into particles of a carbon adsorbent containing oxygen compounds of said metal(s).

In another aspect of the present invention, a method for removing heavy metals comprises the steps of: (1) providing a carbon adsorbent containing a metal selected from the group consisting of iron, copper, aluminum, zirconium, titanium and combinations thereof; and (2) contacting said carbon adsorbent containing said metal with a medium containing the heavy metal cations. In another embodiment, the medium contains heavy metal cations and heavy metal anions such as, for example, arsenic, antimony and selenium. These adsorbents and metals are anticipated to be used with all types of media. Of particular interest, they are used with contaminated water.

Other features and advantages of the present invention will be apparent from a perusal of the detailed description of the invention below.

### DETAILED DESCRIPTION OF THE INVENTION

The present invention provides an adsorbent material and method for removing heavy metals existing in a cationic form in various media. The adsorbent material comprises a porous material wherein at least one oxygen-containing compound of a metal has been incorporated. Remarkably, the adsorbents have been found to overcome shortcomings of traditional carbon adsorbents. The adsorbents retain a substantial amount of their porosity so that they not only remove heavy metal cations such as lead, but the present adsorbents can also remove organic materials from a surrounding medium. Some heavy metals, such as lead, exist in the environment as cations. Because they exist as cations, such metals are soluble in water and thus difficult to remove from solution in water.

The porous material of the present invention is selected from the group consisting of activated carbon, zeolites, activated alumina, ion exchange resins, zirconia, porous silica and combinations thereof. In a preferred embodiment of the invention the porous material is activated carbon. The base carbon (before metal addition) has a large surface area as measured by the Brunauer-Emmett-Teller (“BET”) method, and has a substantial micropore volume. As used herein, “micropore volume” is the total volume of pores having diameter less than about 2 nm. Suitable carbon adsorbents for use in the present invention are those having a BET surface areas greater than about 10 m²/g or about 50 m²/g, preferably greater than about 200 m²/g, and more preferably greater than about 400 m²/g. In an example, the adsorbent has a micropore volume of greater than about 5 cm³/100 g. In another example, the adsorbent has a micropore volume greater than about 20 cm³/100 g.

Suitable carbon adsorbents for use in the present invention may be made from any of a variety of starting carbonaceous materials, such as, but not limited to, coals of various ranks such as anthracite, semianthracite, bituminous, subbituminous, brown coals, or lignites; nutshell; wood; vegetables such as rice hull or straw; residues or by-products from petroleum processing; and natural or synthetic polymeric materials. The carbonaceous material may be processed into carbon adsorbents by any conventional thermal or chemical method known in the art before at least a metal selected from the group consisting of iron, copper, aluminum, zirconium, titanium and combinations thereof is incorporated therein. Alternatively, at least one of the metals may be incorporated into the carbonaceous starting material, then the mixture may be processed into carbon adsorbents containing one or more of such metals. In another aspect of the present invention, the adsorbent is in the form of granule, pellet, sphere, powder, woven fabric, non-woven fabric, mat, felt, block, and honeycomb.

The metal compound in the present invention is selected from the group consisting of compounds of iron, copper, aluminum, zirconium, titanium and combinations thereof. In a preferred embodiment the compound is an oxygen-containing compound of iron, preferably iron hydroxide. In one example, at least one metal is present at a concentration of about 0.01 to about 60% of the weight of the adsorbent material. This concentration is preferably about 1 to about 50% by weight.

In an embodiment, the adsorbent may be disposed in a fixed bed. For instance, the bed may comprise a cartridge or the like that is disposed at the point of use, for example in at a water faucet. In another embodiment the cartridge further comprises at least one adsorbent selected from the group consisting of zeolites, ion exchange resins, silica gel, alumina, and unimpregnated activated carbons. Alternatively, in an example the adsorbent can be disposed in a section of a water supply piping of a house.

In one aspect of the present invention, a porous adsorbent is impregnated with at least one salt of a metal selected from the group consisting of iron, copper, aluminum, zirconium, titanium and combinations thereof. Examples of such salts are halides, nitrates, sulfates, chlorates, and carboxylates having from one to five carbon atoms such as formates, acetates, oxalates, malonates, succinates, or glutarates of iron, copper, aluminum, zirconium, and titanium. The impregnated salts are then converted to oxygen-containing compounds of iron, copper, aluminum, zirconium, and titanium. In an example of an embodiment of the present invention conversion is conducted by either thermal decomposition or chemical reaction. Preferred forms of the oxygen-containing compounds are hydroxides.

In an example, the adsorbent material is prepared by providing a porous adsorbent material, impregnating the porous adsorbent with an aqueous solution comprising at least one compound of at least one metal selected from the group consisting of iron, copper, aluminum, zirconium, titanium and combinations thereof. Then the at least one compound is converted into an oxygen-containing compound of said metal to produce said adsorbent, for example, by thermal decomposition or chemical reaction. The method may include the further step of activating the adsorbent. Preferably the adsorbent material is an activated carbon with a surface area greater than 10 m²/g and a micro pure volume ggreater than 10 cm³/100 g adsorbent. In another embodiment, an alternate preparation method includes: (a) pulverizing a carbonaceous material, a binder, and at least one compound of a metal selected from the group consisting of iron, copper, aluminum, zirconium, titanium and combinations thereof; (b) making a pulverized mixture comprising said carbonaceous material, said binder, and said at least one compound of said metal; (c) compacting the powdered mixture into shaped objects, such as briquettes or pellets; (d) crushing and screening the shaped objects into a metal-containing particulate material; and (e) gasifying said metal-containing particulate material to produce said adsorbent.

The following examples illustrate several embodiments of the present invention, but are not intended to be limiting.

### EXAMPLE 1

To prepare an iron impregnated carbon, 110 grams of anhydrous ferric chloride were dissolved in 73 ml of deionized water. This solution was added to 300 grams of 12×40 mesh (U.S. sieve series) coal based activated carbon identified as HIPUR (Barnebey Sutcliffe Corporation, Columbus, Ohio). The carbon had a BET surface area of 1030 m²/gram. The carbon was mixed thoroughly until all the solution was adsorbed completely. A 50% solution of NaOH was prepared with 110 grams of solid NaOH plus 110 ml of deionized water. This solution was added to the carbon while shaking thoroughly and left to set to allow for complete chemical reaction. The carbon was then washed to remove NaCl from the impregnated carbon. After approximately 10 bed volumes of washing, the carbon was then dried in an oven at 80 degrees Celsius. The final product was activated carbon impregnated with iron hydroxide at 20 g/100 g base carbon.

### EXAMPLE 2

To test the iron-impregnated carbon capability for lead removal, the carbon produced in Example 1 was placed in a 9″×2.5″ filter cartridge, such as used for household water purification. A 150 ppb solution of lead in water was prepared from lead nitrate according to NSF 53 protocol. The water characteristics were also adjusted to a pH of 8.5+0.25. The inlet water flow was set at 0.5 gpm and remained constant through the duration of the experiment. Effluent samples were taken at various intervals and analyzed for lead content by GFAA. The detection limit for this method was below 1 ppb. The results of this filter test are shown in Table A below. As shown, the iron hydroxide impregnated carbon reduced lead to below the EPA action level for over 660 gallons of water treated. This result was surprisingly positive; standard granular activated carbon is not capable of removing lead to acceptable levels at the condition of this test. Commercially available adsorbents that can achieve similar performance (e.g, Engelhard ATC Granules) are very expensive.

TABLE A

| | Effluent Pb Concentration |
|---|---|
| Gallons Treated | (ppb) |
| 150 | 2.1 |
| 330 | 1.3 |
| 510 | 1.7 |
| 660 | 1.3 |
| 870 | 18 |

### EXAMPLE 3

The same coal based activated carbon used in Example 1 was impregnated in the same manner except at an impregnation level of 10 g iron hydroxide per 100 g carbon. Lead removal capability of the impregnated carbon was tested following the same experimental procedure that was used in Example 2. Table B shows the results below. The data show that the carbon successfully removed lead to below the EPA action level for about 420 gallons water treated. However, the lead removal capability was not as great as for a carbon with more iron impregnant (Example 1).

TABLE B

| | Effluent Pb Concentration |
|---|---|
| Gallons Treated | (ppb) |
| 90 | .7 |
| 180 | 3.4 |
| 240 | 2.3 |
| 330 | 8.9 |
| 420 | 14.7 |

### EXAMPLE 4

A coconut based activated carbon (1135 m²/g surface area) was impregnated with iron using the same manner as Example 1 to achieve an impregnation level of 10% by weight (10 g iron hydroxide per 100 g virgin carbon). The same coconut carbon was impregnated at a level of 15% by weight following the same procedure. The test procedures and water characteristics were the same as in Examples 2 and 3 above. Tables C and D below show the results obtained. Table C represents the 10% loading while table D shows data for the 15% impregnation level. These data show that lead removal can be achieved with an activated carbon with a different base material. Again, the higher iron impregnation level yields an adsorbent with higher lead capacity.

TABLE C

| | Effluent Pb Concentration |
|---|---|
| Gallons Treated | (ppb) |
| 90 | .7 |
| 180 | 3.7 |
| 240 | 2.2 |
| 330 | 5.6 |
| 420 | 8.5 |

TABLE D

| | Effluent Pb Concentration |
|---|---|
| Gallons Treated | (ppb) |
| 90 | 3.7 |
| 270 | 1 |
| 390 | 3.6 |
| 510 | .7 |
| 660 | 1.6 |

### EXAMPLE 5

A surface modified coconut base carbon identified as MCAT (Bamebey Sutcliffe Corporation, Columbus, Ohio) was impregnated as in Example 1 but with an impregnation level of 15%. Another coconut base carbon was impregnated at the 7.5% by weight of carbon. The test methods and water characteristics were the same Examples 2 and 3. The tables below show the results obtained with Table E representing the 15% sample and Table F represents the 7.5%. Again, the data show an increase in capacity with a higher level of iron impregnation.

TABLE E

| | Effluent Pb Concentration |
|---|---|
| Gallons Treated | (ppb) |
| 90 | 3 |
| 270 | 1.7 |
| 390 | 2.8 |
| 510 | .5 |
| 660 | 4.5 |

TABLE F

| | Effluent Pb Concentration |
|---|---|
| Gallons Treated | (ppb) |
| 60 | 1.4 |
| 210 | 5.7 |
| 390 | 1.4 |
| 540 | 9.2 |
| 690 | 21.3 |

### EXAMPLE 6

Comparison to activated carbons not impregnated with an oxygen-containing compound of metals:

Two un-impregnated activated carbons that were tested for comparison to absorbents of the subject invention. The test methods and water characteristics were the same as in previous examples. Table G shows the data gathered for coconut shell carbon Type LBD (Barnebey Sutcliffe Corporation, Columbus Ohio). Previous studies had indicated that this particular carbon has somewhat better performance for lead than typical coconut shell carbons. Table H shows the data for an oxidized carbon (Bamebey Sutcliffe Corporation, Columbus Ohio). Previous studies had indicated that oxidizing the surface of activated carbon improves capacity for lead removal. The data below show that neither of these two carbons approaches the high capacity of iron-impregnated carbons for lead removal.

TABLE G

| | Effluent Pb Concentration |
|---|---|
| Gallons Treated | (ppb) |
| 30 | 1.4 |
| 90 | 1.1 |
| 150 | 4.6 |
| 210 | 30.7 |
| 300 | 43.8 |

TABLE H

| | Effluent Pb Concentration |
|---|---|
| Gallons Treated | (ppb) |
| 30 | 2.2 |
| 60 | 7.6 |
| 90 | 23.1 |
| 120 | 34.9 |
| 150 | 60.4 |

### EXAMPLE 7

Three separate 20×50 mesh (U.S. Sieve Series) iron impregnated samples were prepared the same as above with different impregnation levels or a different carbon base materials. The comparison media for these experiments was Engelhard Corporation's lead removal media called ATC 20×50 mesh (U.S. Sieve Series). This material compared with the iron impregnated carbons because of its known and documented capability for lead removal in commercial applications. All variables of the experiment remained the same as above examples, except the filters were tested with a 15 minute on/off cycle with an 8 hour rest period for every 24 hours. This criterion was derived from NSF certification protocol for home water filters. Table I shows the data gathered for the ATC material while Table J shows data for a 10% iron impregnated coconut based carbon. Table K shows the data for a 20% impregnation by carbon weight with the base material identified as CPG (Calgon Carbon Corporation, Pittsburgh, Pa.). Table L shows a 10% impregnation level with a base material previously identified as MCAT (Bamebey Sutcliffe Corporation, Columbus, Ohio). The data demonstrate that the iron impregnated carbons can give lead removal performance similar to that of state-of-the art commercial media for lead removal.

TABLE I

| | Effluent Pb Concentration |
|---|---|
| Gallons Treated | (ppb) |
| 287 | 4 |
| 885 | .3 |
| 1750 | 1.1 |
| 2630 | 3.1 |
| 3435 | .2 |

TABLE J

| | Effluent Pb Concentration |
|---|---|
| Gallons Treated | (ppb) |
| 204 | 2.1 |
| 800 | .8 |
| 1225 | 1.6 |
| 1675 | 2.0 |
| 2610 | 6.7 |

TABLE K

| | Effluent Pb |
|---|---|
| Gallons Treated | Concentration (ppb) |
| 213 | 2.8 |
| 700 | .4 |
| 1217 | 1.8 |
| 1815 | 2.1 |
| 2440 | 2.1 |

TABLE L

| | Effluent Pb |
|---|---|
| Gallons Treated | Concentration (ppb) |
| 283 | 2.6 |
| 805 | .6 |
| 1796 | 1.3 |
| 2600 | 2 |
| 3430 | .5 |

### EXAMPLE 8

A sample of carbon identified as DCL 1240 (Bamebey Sutcliffe Corporation, Columbus, Ohio) was impregnated with 50% FeOOH by carbon weight using the procedure of Example 1. The DCL carbon had a high total pore volume (1200 Iodine Number, >400 Molasses Number). This allowed incorporation of high levels of iron hydroxide.

### EXAMPLE 9

The media prepared in Example 8 was tested for removal of arsenic from water. The challenge water was prepared per NSF 53 high pH protocol. The arsenic concentration was obtained by adding sodium arsenate to the water for an approximate theoretical concentration of 100 ppb. The analysis was performed by GFAA with a detection limit of less than 1 ppb. Table M below shows the data generated. The data demonstrate that the iron-impregnated media can be effective for removal of metal anions, as well as metal cations, thus providing a multi-purpose metal adsorbent.

TABLE M

| | Effluent As |
|---|---|
| Gallons Treated | Concentration (ppb) |
| 30 | 7 |
| 60 | 6 |
| 150 | 10 |
| 180 | 20 |
| 240 | 54 |

### EXAMPLE 10

Testing was conducted to determine removal of metals other than lead and arsenic.

A carbon impregnated with 30% ferric hydroxide was prepared in the same manner as previous examples with ACL carbon used as the base material. A 9″ filter was filled with this material while another filter was filled with virgin (un-impregnated) 20×50 ACL for comparison. The challenge solution was comprised of deionized water with the addition of sodium selenite, nickel chloride, zinc nitrate, mercury nitrate, cupric sulfate and sodium cobaltinitrite. The amount of each chemical added to the water to give ca. 100 ppb concentration of each metal in solution. Water flow was set at 0.25 gpm (continuous). Several effluent samples were taken and analyzed by ICP-MS with the results shown below. Table M gives the results for the impregnated carbon while Table N lists the results of the virgin ACL material.

TABLE M
(Iron-Impregnated Carbon)

| | Co | Cu | Hg | Ni | Se | Zn |
|---|---|---|---|---|---|---|
| Gallons | (ppb) | (ppb) | (ppb) | (ppb) | (ppb) | (ppb) |
| Challenge | 97.7 | 136 | 88.9 | 126 | 104 | 101 |
| 45 | 20.5 | 16.8 | 1.2 | 12.9 | 3.4 | 13 |
| 91 | 8.41 | .4 | 1.2 | 8.4 | 5 | 1.2 |
| 138 | 9.6 | 1.5 | 1.2 | 2.9 | 2.6 | 2.9 |
| 182 | 12.3 | .4 | 1.9 | 19 | 4.8 | 1 |

TABLE N
(Virgin Carbon)

| | Co | Cu | Hg | Ni | Se | Zn |
|---|---|---|---|---|---|---|
| Gallons | (ppb) | (ppb) | (ppb) | (ppb) | (ppb) | (ppb) |
| Challenge | 97.7 | 136 | 88.9 | 126 | 104 | 101 |
| 15 | 61.8 | 50 | 14 | 78.1 | 2.7 | 41.3 |
| 40 | 46.2 | 19 | 29.8 | 81.7 | 17.8 | 27.2 |
| 125 | 48.8 | .54 | 35.3 | 98 | 119 | 65.2 |
| 170 | 46.6 | .59 | 54.7 | 91.8 | 113 | 58.4 |

The data show that ferric hydroxide impregnated carbon is effective in removing cobalt, mercury, nickel, selenium and zinc from aqueous solution.

While various embodiments are described herein, it will be appreciated from the specification that various combinations of elements, variations, equivalents, or improvements therein may be made by those skilled in the art, and are still within the scope of the invention as defined in the appended claims.

1. An adsorbent for removing cations of a heavy metal from a medium surrounding said adsorbent, said adsorbent comprising a porous media selected from the group consisting of activated carbon, zeolites, activated alumina, ion exchange resins, zirconia, porous silica and combinations thereof, and has incorporated therein at least one oxygen-containing compound of at least one metal selected from the group consisting of iron, copper, aluminum, zirconium, titanium and combinations thereof.

2. The adsorbent according to claim 1, wherein said at least one oxygen-containing compound of said at least one metal is incorporated into said porous carbon by a method selected from the group consisting of impregnation and dispersion within said adsorbent.

3. The adsorbent according to claim 1, wherein said at least one oxygen-containing compound of said at least one metal is a hydroxide.

4. The adsorbent according to claim 1, wherein said heavy metal removed is selected from the group consisting of lead, copper, nickel, cobalt, cadmium, zinc, mercury and combinations thereof.

5. The adsorbent according to claim 1, wherein said adsorbent has a BET surface area greater than about 20 m²/g.

6. The adsorbent according to claim 1, wherein said adsorbent has a micropore volume of greater than about 5 cm³/100 g of adsorbent.

7. The adsorbent according to claim 1, wherein said at least one metal is present at a concentration in the range of about 0.01 to about 60% by weight of said porous carbon.

8. A method for making an adsorbent for a removal of cations of the heavy metal, said method comprising the steps of:
a. providing a porous adsorbent;
b. impregnating said porous adsorbent with a solution comprising at least one compound of at least one metal selected from the group consisting of iron, copper, aluminum, zirconium, titanium and combinations thereof; and
c. converting said at least one compound into an oxygen-containing compound of said metal to produce said adsorbent.

9. The method according to claim 8 further including step (d) of activating said adsorbent.

10. The method according to claim 8, wherein said porous adsorbent is an activated carbon.

11. The method according to claim 8, wherein said at least one compound of said metal is selected from the group consisting of halides, nitrates, sulfates, chlorates, and carboxylates having from one to and including five carbon atoms.

12. The method according to claim 8, wherein said step of converting comprises a process selected from the group consisting of thermal decomposition and chemical reaction.

13. The method according to claim 8, wherein said oxygen-containing compound is selected from the group consisting of oxides, hydroxides and combinations thereof.

14. The method according to claim 10, wherein said activated carbon is selected from the group consisting of coal-, wood-, nut shell-, petroleum residue-, vegetable-based activated carbons; said activated carbon having a BET surface area greater than about 10 m²/g.

15. The method according to claim 10, wherein said activated carbon is selected from the group consisting of coal-, wood-, nut shell-, petroleum residue-, vegetable-based activated carbons; said activated carbon having a micropore volume greater than about 10 cm³/100 g of adsorbent.

16. The method according to claim 8, wherein said at least one metal is present at a concentration from about 0.01 to about 60% by weight of said porous adsorbent.

17. A method for making an adsorbent for a removal of anions of a heavy metal, said method comprising the steps of:
(a) pulverizing a carbonaceous material, a binder, and at least one compound of a metal selected from the group consisting of iron, copper, aluminum, zirconium, titanium and combinations thereof;
(b) making a pulverized mixture comprising said carbonaceous material, said binder, and said at least one compound of said metal;
(c) compacting the powdered mixture into shaped objects;
(d) crushing and screening the shaped objects into a metal-containing particulate material; and
(e) gasifying said metal-containing particulate material to produce said adsorbent.

18. The method according to claim 17, wherein said carbonaceous material, said binder, and said at least one compound of said metal are pulverized together or are pulverized separately before said pulverized mixture is made.

19. The method according to claim 17, wherein said compacting is selected from the group consisting of briquetting, pelletizing, densifying, and extruding.

20. The method according to claim 17, wherein said gasifying is conducted under an atmosphere comprising an oxygen-containing gas at a temperature in a range from about 700 to about 1100° C., for a time sufficient to produce an adsorbent having a BET surface area of at least 50 m²/g.

21. The method according to claim 17 further comprising the step of oxidizing said metal-containing particulate material before the step of gasifying.

22. The method according to claim 21, wherein said gasifying is conducted under an atmosphere comprising an oxygen-containing gas at a temperature in a range from about 700 to about 1100° C., for a time sufficient to produce an adsorbent having a BET surface area of at least 10 m²/g.

23. A method for removing cations of a heavy metal from a starting medium, said method comprising the steps of:
(a) providing an adsorbent comprising a porous media incorporated therein at least one oxygen-containing compound of at least one metal selected from the group consisting of iron, copper, aluminum, zirconium, titanium and combinations thereof;
(b) contacting a portion of said starting medium containing said cations of said heavy metal with said adsorbent; and
(c) obtaining a treated medium having a lower concentration of said heavy metal than a concentration of said heavy metal of said starting medium.

24. The method according to claim 23, wherein said at least one oxygen-containing compound of said at least one metal is incorporated into said porous media by a method selected from the group consisting of impregnation and dispersion within said adsorbent.

25. The method according to claim 23, wherein said at least one oxygen-containing compound of said at least one metal is a hydroxide.

26. The method according to claim 23, wherein said heavy metal is selected from the group consisting of lead, copper, nickel, cobalt, cadmium, zinc, mercury and combinations thereof.

27. The method according to claim 23, wherein said adsorbent has a BET surface area greater than about 50 m²/g.

28. The method according to claim 23, wherein said adsorbent has a micropore volume of greater than about 20 cm³/100 g of adsorbent.

29. The method according to claim 23, wherein said at least one metal is present at a concentration in the range from about 0.01 to about 60% by weight of said porous media.

30. A method for removing cations of a heavy metal from a starting medium, said method comprising the steps of:
(a) providing an adsorbent comprising a porous media incorporated therein at least one oxygen-containing compound of at least one metal selected from the group consisting of iron, copper, aluminum, zirconium, titanium and combinations thereof;
(b) contacting a portion of said starting medium containing said cations of said heavy metal with said adsorbent; and
(c) obtaining a treated medium having a lower concentration of said heavy metal than a concentration of said heavy metal of said starting medium; wherein; said heavy metal is selected from the group consisting of lead, copper, nickel, cobalt, cadmium, zinc, mercury and combinations thereof; said at least one oxygen-containing compound is a hydroxide; said at least one metal is present at a concentration from about 0.01 to about 60 percent by weight of said porous carbon.

31. The method according to claim 30, wherein said adsorbent has a form selected from the group consisting of granule, pellet, sphere, powder, woven fabric, non-woven fabric, mat, felt, block, and honeycomb.

32. The method according to claim 30, wherein said adsorbent is disposed at a point of use.

33. The method according claim 30, wherein said adsorbent is disposed in a fixed bed.

34. The method according claim 32, wherein said adsorbent is disposed in a section of a water supply piping of a house.

35. The method according to claim 33, wherein said fixed bed comprises a cartridge that is disposed at a water faucet.

36. The method according to claim 35, wherein said cartridge further comprises at least one adsorbent selected from the group consisting of zeolites, ion exchange resins, silica gel, alumina, and unimpregnated activated carbons.

37. The method according to claim 30, by which other water contaminants are remove d along with heavy metal cations, wherein said contaminants include heavy metal anions, organic compounds commonly adsorbed by activated carbon, chlorine or combinations thereof.
